(19) United States
(12) Patent Application Publication
(10) Pub. No.: US 2021/0286208 A1
(43) Pub. Date: Sep. 16, 2021

(54) ARRAY SUBSTRATE AND LIQUID CRYSTAL DISPLAY PANEL

(71) Applicant: TCL CHINA STAR OPTOELECTRONICS TECHNOLOGY CO., LTD., Shenzhen, Guangdong (CN)

(72) Inventor: Zixiang ZHANG, Shenzhen, Guangdong (CN)

(21) Appl. No.: 16/765,171

(22) PCT Filed: Apr. 2, 2020
(86) PCT No.: PCT/CN2020/082913

§ 371 Date: May 19, 2020

(30) Foreign Application Priority Data
Mar. 16, 2020 (CN) 202010179661.0

(51) Int. Cl. G02F 1/1368; G02F 1/1343; G02F 1/1339; G02F 1/1335; G02F 1/1362

(52) U.S. Cl. CPC G02F 1/1368; G02F 1/134309; G02F 1/13394; G02F 2001/136222; G02F 1/136286; G02F 1/136227; G02F 1/133512

(57) ABSTRACT

The present application provides an array substrate and a liquid crystal display panel. The array substrate includes a base substrate, a thin film transistor (TFT) layer and a color resist layer arranged on the base substrate, a pixel electrode layer arranged on the color resist layer, and first spacers. The first spacer and the TFT are staggered in a vertical direction. The liquid crystal display panel includes the above-mentioned array substrate.

### FIELD OF DISCLOSURE

The present invention relates to a field of display technology and in particular, to an array substrate and a liquid crystal display panel.

### DESCRIPTION OF RELATED ART

Liquid crystal displays (LCDs) have many advantages such as being thin, power saving, and no radiation, so they are extensively used in the field of display devices. At present, common display devices, such as LCD TVs, mobile phones, computer monitors, and notebook computers, often use LCD technology.

The structure of a liquid crystal display panel generally includes a backlight module, a thin film transistor (TFT) array substrate, a color filter substrate, and a liquid crystal layer disposed between the TFT array substrate and the color filter substrate. A gap spacer is also disposed between the array substrate and the color filter substrate to maintain an accommodating space of the liquid crystal layer so as to prevent the array substrate and the color filter substrate from approaching each other and squeezing the liquid crystal layer. In COA (color filter on array) substrates, a color resist layer originally set on the color filter substrate is directly made on the array substrate. This structure is widely used as it can eliminate the influence of the color resist layer's alignment accuracy problem on the display panel. In conventional techniques, in order to avoid the influence of the gap spacer on an aperture ratio of the COA substrate, the gap spacer is disposed above a thin film transistor of the array substrate and is shielded by a black matrix in the LCD panel. In a service life of the panel, the gap spacers have been subjected to more or less squeezing force, and this squeezing force finally acts on the thin film transistor. The thin film transistor is pressed by the gap spacer for a long time to lead to abnormal electrical performance of the thin film transistor, and eventually cause abnormal display performance of the LCD panel.

In conventional techniques, gap spacers disposed above the thin film transistor of an array substrate will exert a squeezing force on the thin film transistors. The thin film transistors are subjected to the squeezing action of the gap spacers for a long period of time, which causes abnormal electrical performance and eventually, causes abnormal display performance of liquid crystal display panels.

### SUMMARY

Accordingly, the present application provides a solution as follows.

The present application provides an array substrate, comprising:

a base substrate;

a thin film transistor (TFT) layer disposed on the base substrate, the TFT layer comprising a plurality of TFTs;

a color resist layer disposed on the base substrate and covering the TFT layer, wherein a plurality of openings are defined in the color resist layer, and the opening and the TFT are staggered in a vertical direction;

a pixel electrode layer disposed on the color resist layer, wherein the pixel electrode layer is electrically connected to the TFT through the opening; and

a plurality of first spacers disposed on the color resist layer, wherein the first spacer and the TFT are staggered in a vertical direction.

In the array substrate of the present application, the base substrate is a glass substrate or a polyimide substrate.

In the array substrate of the present application, the TFT layer further comprises a plurality of scanning lines and a plurality of data lines electrically connected to the TFTs, the scanning lines provide scanning signals for the TFTs, and the data lines provide data signals for the TFTs.

In the array substrate of the present application, the pixel electrode layer comprises a plurality of pixel electrodes, and three openings are defined between adjacent two of the pixel electrodes along an extending direction of the data line.

In the array substrate of the present application, the first spacer is disposed between adjacent two of the pixel electrodes and between adjacent two of the openings.

In the array substrate of the present application, the pixel electrode layer comprises a plurality of pixel electrodes, and two openings are defined between adjacent two of the pixel electrodes in an extending direction of the data line.

In the array substrate of the present application, the first spacer is disposed in a blank area between adjacent two of the pixel electrodes excluding an area where the openings and the TFT are located.

In the array substrate of the present application, the first spacer partially covers the opening.

In the array substrate of the present application, the first spacer and the opening are staggered in the vertical direction.

In the array substrate of the present application, the color resist layer comprises a plurality of openings, and the first spacer is disposed between adjacent two of the openings.

In the array substrate of the present application, an outermost layer of the color resist layer is provided with a passivation layer, and the first spacer is disposed on the passivation layer.

In the array substrate of the present application, the array substrate further comprises a plurality of second spacers, the second spacers are disposed on the color resist layer, and a height of the second spacer is less than a height of the first spacer.

In the array substrate of the present application, the second spacer is disposed corresponding to the TFT in the vertical direction, or the second spacer and the TFT are staggered in the vertical direction.

In the array substrate of the present application, the color resist layer comprises a red color resist, a green color resist, and a blue color resist which are respectively disposed corresponding to a red pixel region, a green pixel region, and a blue pixel region of the array substrate, the first spacer is disposed on the blue color resist, and the second spacer is disposed on the red color resist and/or the green color resist.

The present application provides a liquid crystal display panel, comprising:

the array substrate of claim 1;

an upper substrate disposed corresponding to the array substrate, the upper substrate comprising a black matrix arranged in an array pattern; and

a liquid crystal layer disposed between the array substrate and the upper substrate.

The present application further provides a liquid crystal display panel, comprising:

an array substrate, an upper substrate disposed corresponding to the array substrate, and a liquid crystal layer disposed between the array substrate and the upper substrate;

wherein the array substrate comprises:
a base substrate;
a thin film transistor (TFT) layer disposed on the base substrate, the TFT layer comprising a plurality of TFTs;

a color resist layer disposed on the base substrate and covering the TFT layer, wherein a plurality of openings are defined in the color resist layer, and the opening and the TFT are staggered in a vertical direction;

a pixel electrode layer disposed on the color resist layer, wherein the pixel electrode layer comprises a plurality of pixel electrodes, and the pixel electrodes are electrically connected to the TFTs through the openings; and

a plurality of first spacers disposed on the color resist layer, wherein the first spacer, the TFT, and the opening are staggered in a vertical direction;

wherein the upper substrate comprises a black matrix arranged in an array pattern.

In the liquid crystal display panel of the present application, the array substrate further comprises a second spacer disposed on the color resist layer, a height of the second spacer is less than a height of the first spacer, and the second spacer is disposed corresponding to the TFT in the vertical direction or staggered from the TFT in the vertical direction.

In the liquid crystal display panel of the present application, the first spacer and the second spacer are correspondingly disposed under the black matrix.

Advantages of the present application:

In the array substrate and the liquid crystal display panel of the present application, the first spacer and the thin film transistor in the array substrate are vertically staggered to prevent the first spacer from pressing the TFT for a long time and causing abnormal function thereof. Thereby, the liquid crystal display panel can provide stable performance, and user experience is improved.

### BRIEF DESCRIPTION OF DRAWINGS

In order to more clearly illustrate the embodiments of the present disclosure or related art, figures which will be described in the embodiments are briefly introduced hereinafter. It is obvious that the drawings are merely for the purposes of illustrating some embodiments of the present disclosure, and a person having ordinary skill in this field can obtain other figures according to these figures without inventive work.

FIG. 1 is a schematic partial structural view illustrating an array substrate according to one embodiment of the present application.

FIG. 2 is a cross-sectional view taken along line A-A′ in FIG. 1 illustrating the array substrate.

FIG. 3 is a schematic partial structural view illustrating the array substrate according to another embodiment of the present application.

FIG. 4 is a cross-sectional view taken along line A-A′ in FIG. 3 illustrating the array substrate.

FIG. 5 is a schematic structural view illustrating a liquid crystal display panel according to one embodiment of the present application.

### DETAILED DESCRIPTION OF EMBODIMENTS

The following description is provided with reference to the accompanying drawings to illustrate specific embodiments of the present application. Directional terms mentioned in the present application, such as “upper”, “lower”, “front”, “rear”, “left”, “right”, “inner”, “outer”, and “lateral”, are for illustrative purposes based on the accompanying drawings. Therefore, the directional terms are only used to illustrate and understand this application, but not to limit it. In the drawings, elements with similar structures are denoted by the same reference numerals.

An array substrate is provided according to one embodiment of the present application. The array substrate comprises a first spacer that functions as a support. The first spacer and a thin film transistor (TFT) in the array substrate are staggered in a vertical direction. In the case where the array substrate is used in a liquid crystal display (LCD) panel, the first spacer supports an upper substrate of the LCD panel, and a downward force is exerted by the first spacer but not acts on the TFT. Therefore, abnormal functioning of the TFT caused by being pressed for a long time is avoided, and display quality of the LCD panel is improved.

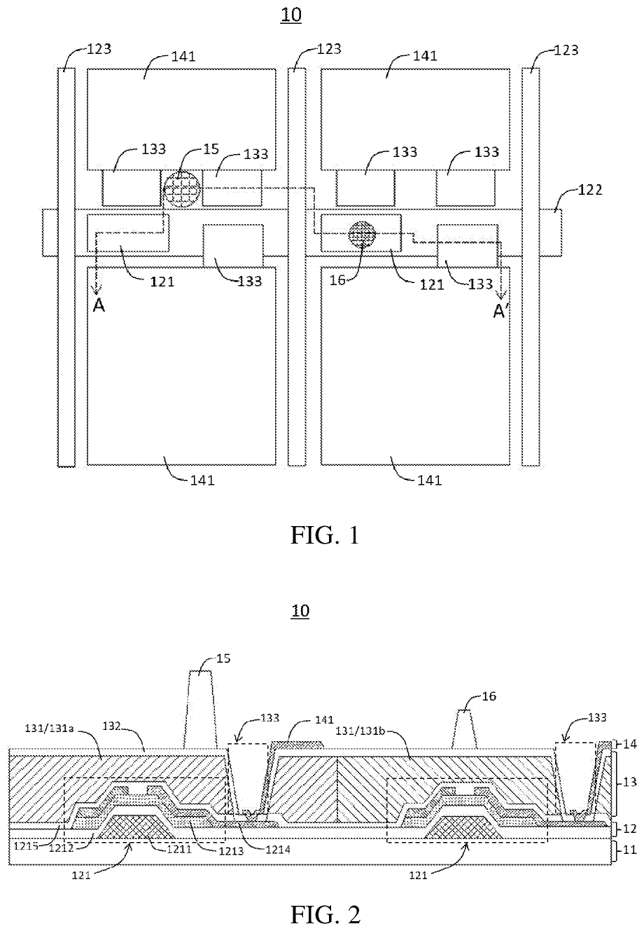

Please refer to FIGS. 1 and 2. FIG. 1 is a schematic partial structural view illustrating an array substrate according to one embodiment of the present application. FIG. 2 is a cross-sectional view taken along line A-A′ in FIG. 1 illustrating the array substrate. The array substrate 10 of the present application comprises a base substrate 11, a thin film transistor (TFT) layer 12, a color resist layer 13, and a pixel electrode layer 14. It should be noted that, FIG. 1 is only a partial structural view of the array substrate 10 for clarity in illustration of the structure of the array substrate 10. The structural features of the array substrate 10 appear in a regular and repetitive pattern, so those skilled in the art can easily obtain the complete structure of the array substrate 10 according to the drawings and text descriptions of the embodiments of the present application. In addition, in order to clearly illustrate key structural features of the present embodiment, FIG. 2 is a schematic cross-sectional structural view shows a revolved section of the array substrate 10.

The base substrate 11 serves as a base layer of the array substrate 10 and plays a role of carrying and supporting elements in the array substrate 10. The base substrate 11 can be a rigid substrate such as a glass substrate, or can be a flexible substrate such as a polyimide substrate.

The TFT layer 12 is disposed on the base substrate 11. Selectively, for better connection relationship between the base substrate 11 and the TFT layer 12, a buffer layer is disposed between the base substrate 11 and the TFT layer 12, wherein the buffer layer can be a layered structure of an organic layer/an inorganic layer/an organic layer.

The TFT layer 12 comprises a plurality of TFTs 121, and a scan line 122 and a data line 123 electrically connected to the TFTs 121. Specifically, the TFT 121 comprises a gate layer 1211, a gate insulating layer 1212, an active layer 1213, and a source/drain layer 1214. The gate layer 1211 is disposed on the base substrate 11. The gate insulating layer 1212 is disposed on the base substrate 11 and covers the gate layer 1211. The active layer 1213 is disposed on the gate insulating layer 1212, and the source/drain layer 1214 is disposed on the active layer 1213. The scan line 122 and the gate layer 1211 are arranged in a same layer and are electrically connected. The data line 123 and the source/drain layer 1214 are in a same layer, and the data line 123 is electrically connected to a source electrode in the source/drain layer 1214. It should be understood that the scan line 122 is configured to provide a scan signal to the TFT 121 to control an on/off state of the source electrode and a drain electrode in the TFT 121. The data line 123 is configured to supply a control signal to the TFT 121 to control functioning of the array substrate 10.

Selectively, the thin film transistor 121 includes a first passivation layer 1215 disposed in an outer layer thereof. The first passivation layer 1215 completely covers the active layer 1213 and the source/drain layer 1214. The first passivation layer 1215 can be made of an inorganic insulating material such as silicon nitride.

The color resist layer 13 is disposed on the base substrate 11 and covers the TFT layer 12. A plurality of openings 133 are defined in the color resist layer 13. The opening 133 and the TFT 121 are staggered in a vertical direction. It should be noted that, the vertical direction refers to a thickness direction of the array substrate 10. The opening 133 and the TFT 121 being staggered in the vertical direction means that a vertical projection of the opening 133 projected on the base substrate 11 and a vertical projection of the TFT 121 projected on the base substrate 11 do not overlap each other or only partially overlap at their edge portions.

The pixel electrode layer 14 is disposed on the color resist layer 13. In detail, an outermost layer of the color resist layer 13 is provided with a second passivation layer 132. The pixel electrode layer 14 is disposed on the second passivation layer 132. The second passivation layer 132 is made of an inorganic insulating material such as silicon nitride.

The pixel electrode layer 14 includes multiple pixel electrodes 141. The pixel electrode 141 is electrically connected to the TFT layer 12 through the opening 133. Specifically, the second passivation layer 132 extends along the opening 133 onto the TFT layer 12 and forms a via hole at a position where it contacts the source/drain electrode 1214 of the TFT 121. The pixel electrode 141 is electrically connected to the source/drain electrode 1214 through the opening 133 and the via hole, so that the pixel electrode 141 can receive data signals transmitted from the TFT 121.

The array substrate 10 includes multiple pixel electrodes 141, and each of the pixel electrodes 141 is arranged corresponding to a pixel region. Three openings 133 are arranged between two adjacent pixel electrodes 141 along an extending direction of the data line 123, and the first spacer 15 is disposed between two adjacent pixel electrodes 141 and disposed between two adjacent openings 133. The first spacer 15 and the opening 133 are staggered in the vertical direction, that is, a vertical projection of the first spacer 15 and a vertical projection of the opening 133 projected on the base substrate 11 do not coincide. Furthermore, selectively, the first spacer 15 partially covers at least one of the openings 133, that is, a vertical projection of the first spacer 15 and at least one of the openings 133 projected on the base substrate 11 partially coincide. It should be noted that, the above-mentioned positional arrangement of the first spacer 15 can ensure that when the array substrate 10 is used in a display panel, the first spacer 15 is covered by the black matrix in an upper substrate, and at the same time, the first spacer 15 is prevented from pressing the TFT 121.

Selectively, the array substrate 10 further selectively includes a second spacer 16 disposed on the color resist layer 13. A height of the second spacer 16 is less than a height of the first spacer 15. The second spacer 16 can be disposed corresponding to the TFT 121 in the vertical direction, or can be disposed staggered from the TFT 121 in the vertical direction. It should be noted that, the second spacer 16 functions as an auxiliary support. To be specific, when the array substrate 10 is used in a liquid crystal display panel, the second spacer 16 only provides a support force when the liquid crystal display panel is under a larger pressing or squeezing force.

Selectively, the color resist layer 13 comprises a plurality of color resists 131, and each of the color resists 131 is arranged corresponding to a pixel region. The color resists 131 can include a blue color resist 131a, a red color resist 131b, and a green color resist (not illustrated) which are respectively disposed corresponding to a red pixel region, a green pixel region, and a blue pixel region of the array substrate 10. The first spacer 15 is disposed above the blue color resist 131a, and the second spacer 16 is disposed above the red color resist 131b and/or the green color resist.

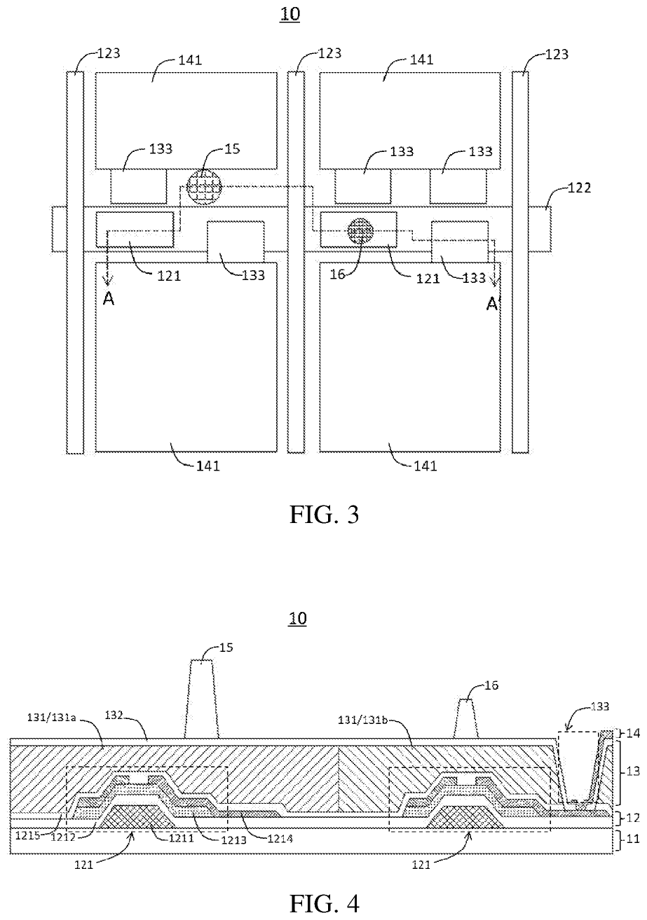

FIGS. 3 and 4 are schematic views illustrating the array substrate 10 according to another embodiment of the present application, and are different from the embodiment of the array substrate 10 shown in FIGS. 1 and 2 in the following aspects. Two openings 133 are arranged between two adjacent pixel electrodes 141 in the extending direction of the data line 123. The first spacer 15 is disposed in a blank area, between adjacent two of the pixel electrodes 141, excluding an area where the openings 133 and the TFT 121 are located. Moreover, the first spacer 15 is staggered from the opening 133 and the TFT 121 in the vertical direction. Selectively, the first spacer 15 can partially cover the opening 133. It should be noted that, the above-mentioned positional arrangement of the first spacer 15 can ensure that when the array substrate 10 is used in a display panel, the first spacer 15 is covered by the black matrix in the upper substrate, and the first spacer 15 is prevented from pressing the TFT 121.

In summary, the array substrate of the present embodiment comprises a first spacer which functions as a support, and the first spacer and the TFT in the array substrate are staggered in the vertical direction. When the array substrate is used in a liquid crystal display panel, a downward force generated by the first spacer does not act on the TFT, thereby preventing long-term pressing on the TFT, which could result in abnormal functions, thus improving the display quality of the liquid crystal display panel.

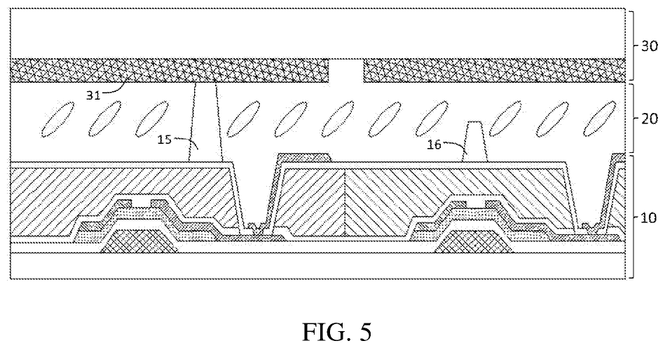

A liquid crystal display panel is provided according to one embodiment of the present invention. As shown in FIG. 5, the liquid crystal display panel includes the array substrate 10 of the above embodiment, an upper substrate 30 disposed corresponding to the array substrate 10, and a liquid crystal layer 20 disposed between the array substrate 10 and the upper substrate 30. The upper substrate 30 is provided with a black matrix 31 arranged in an array pattern, the first spacer 15 and the second spacer 16 are correspondingly arranged under the black matrix 31, and the first spacer 15 and the second spacer 16 are used to support the upper substrate 30. It should be noted that, in the liquid crystal display panel, the black matrix 31 is used to cover an opaque metal covering area in the array substrate 10, especially an area between two adjacent pixel electrodes 141 (see FIG. 1), which includes the TFT 121, the data line 123, and the scan line 122 between the pixel electrodes 141. Therefore, the first spacer 15 and the second spacer 16 are also covered by the black matrix 31.

In summary, in the liquid crystal display panel of the present application, the first spacer and the thin film transistor in the array substrate are vertically staggered to prevent the first spacer from pressing the TFT for a long time and causing abnormal function thereof. Thereby, the liquid crystal display panel provides stable performance, and user experience is improved.

In summary, although the present invention has been disclosed above with specific embodiments, the above embodiments are not intended to limit the present invention. Those skilled in the art can make various modifications without departing from the spirit and scope of the present invention. The protection scope of the present invention should be defined by the appended claims.

1. An array substrate, comprising:
a base substrate;
a thin film transistor (TFT) layer disposed on the base substrate, the TFT layer comprising a plurality of TFTs;
a color resist layer disposed on the base substrate and covering the TFT layer, wherein a plurality of openings are defined in the color resist layer, and the plurality of openings and the plurality of TFTs are staggered in a vertical direction;
a pixel electrode layer disposed on the color resist layer, wherein the pixel electrode layer is electrically connected to the TFTs through the openings;
a passivation layer disposed on the color resist layer, wherein the passivation layer is made of an inorganic insulating material;
a plurality of first spacers disposed on the color resist layer, wherein the plurality of first spacers, the plurality of TFTs, and the plurality of openings are staggered in the vertical direction; and
a plurality of second spacers disposed on the color resist layer, wherein a height of each of the second spacers is less than a height of each of the first spacers, the plurality of second spacers are disposed corresponding to the plurality of TFTs in the vertical direction, and each of the first spacers and each of the second spacers are disposed on the passivation layer.

2. The array substrate according to claim 1, wherein the base substrate is a glass substrate or a polyimide substrate.

3. The array substrate according to claim 1, wherein the TFT layer further comprises a plurality of scanning lines and a plurality of data lines electrically connected to the TFTs, the scanning lines provide scanning signals for the TFTs, and the data lines provide data signals for the TFTs.

4. The array substrate according to claim 3, wherein the pixel electrode layer comprises a plurality of pixel electrodes, and three openings are defined between adjacent two of the pixel electrodes along an extending direction of the data lines.

5. The array substrate according to claim 4, wherein each of the first spacers is disposed between adjacent two of the pixel electrodes and between adjacent two of the openings.

6. The array substrate according to claim 3, wherein the pixel electrode layer comprises a plurality of pixel electrodes, and two openings are defined between adjacent two of the pixel electrodes in an extending direction of the data lines.

7. The array substrate according to claim 6, wherein each of the first spacers is disposed in a blank area between adjacent two of the pixel electrodes excluding an area where the openings and the TFTs are located.

8. The array substrate according to claim 1, wherein each of the first spacers partially covers a corresponding one of the openings.

9-13. (canceled)

14. The array substrate according to claim 1, wherein the color resist layer comprises a red color resist, a green color resist, and a blue color resist which are respectively disposed corresponding to a red pixel region, a green pixel region, and a blue pixel region of the array substrate, one of the first spacers is disposed on the blue color resist, and one of the second spacers is disposed on the red color resist and/or the green color resist.

15. A liquid crystal display panel, comprising:
the array substrate of claim 1;
an upper substrate disposed corresponding to the array substrate, the upper substrate comprising a black matrix arranged in an array pattern; and
a liquid crystal layer disposed between the array substrate and the upper substrate.

16. A liquid crystal display panel, comprising:
an array substrate, an upper substrate disposed corresponding to the array substrate, and a liquid crystal layer disposed between the array substrate and the upper substrate;
wherein the array substrate comprises:
a base substrate;
a thin film transistor (TFT) layer disposed on the base substrate, the TFT layer comprising a plurality of TFTs;
a color resist layer disposed on the base substrate and covering the TFT layer, wherein a plurality of openings are defined in the color resist layer, and the plurality of openings and the plurality of TFTs are staggered in a vertical direction;
a pixel electrode layer disposed on the color resist layer, wherein the pixel electrode layer comprises a plurality of pixel electrodes, and the pixel electrodes are electrically connected to the TFTs through the openings;
a passivation layer disposed on the color resist layer, wherein the passivation layer is made of an inorganic insulating material;
a plurality of first spacers disposed on the color resist layer, wherein the plurality of first spacers, the plurality of TFTs, and the plurality of openings are staggered in the vertical direction; and
a plurality of second spacers disposed on the color resist layer, wherein a height of each of the second spacers is less than a height of each of the first spacers, the plurality of second spacers are disposed corresponding to the plurality of TFTs in the vertical direction, and each of the first spacers and each of the second spacers are disposed on the passivation layer;
wherein the upper substrate comprises a black matrix arranged in an array pattern.

17. (canceled)

18. The liquid crystal display panel according to claim 16, wherein the plurality of first spacers and the plurality of second spacers are correspondingly disposed under the black matrix.
